(19) United States
(12) Patent Application Publication
(10) Pub. No.: US 2022/0353134 A1
(43) Pub. Date: Nov. 3, 2022

(54) VIRTUAL NETWORK FUNCTION UPGRADE TOOL

(71) Applicant: MICROSOFT TECHNOLOGY LICENSING, LLC, Redmond, WA (US)

(72) Inventors: Andrew LEE, Enfield (GB); Murray William ROGERS, Enfield (GB); David Charles HOTHAM, Enfield (GB); Duncan ARCHER, Durham (GB); Sophie STRATTON, Edinburgh (GB); Joseph Ellis Darracott POWELL, London (GB); Sunniva CARTER, Enfield (GB)

(21) Appl. No.: 17/244,934

(22) Filed: Apr. 29, 2021

(51) Int. Cl. H04L 12/24; H04L 12/46; G06F 9/455; G06F 8/656

(52) U.S. Cl. CPC H04L 41/082; H04L 12/4641; G06F 9/45558; G06F 8/656; G06F 2009/45562; G06F 2009/4557

(57) ABSTRACT

Techniques are described for upgrading a virtualized network function (VNF) implemented in a virtualized computing environment configured in a user-specific configuration. The virtualized network function is implemented by a plurality of VNF components (VNFCs) executing in a plurality of virtual machines managed by a virtualized infrastructure manager (VIM). An upgrade component is configured to execute as a virtual resource and execute a series of operations that coordinate an upgrade of the VNFCs implementing the VNF and interact with the VIM and the virtual machines to effect the upgrade. A configuration file pertaining to a new software version defining the upgrade and a set of upgrade instructions. Based on the configuration file, the upgrade instructions are translated to a series of operations on the virtual machines and interactions with the VIM to effect the upgrade.

### BACKGROUND

Service providers can provide computing services to businesses and individuals as a remote computing service or provide “software as a service” (e.g., cloud computing). In some cases, users may deploy products and services from service providers on their own premises. When deploying resources, such as virtualized resources, in a customer computing environment, various issues may arise, resulting in deployment delays which in turn can prevent the customer from providing services to their downstream users. This can lead to lost revenue and customer dissatisfaction. Production loss and inefficiencies with respect to computing resources can be exacerbated when configuration issues arise and the service provider is unable to quickly isolate and correct the cause of a misconfiguration issue.

It is with respect to these considerations and others that the disclosure made herein is presented.

### SUMMARY

The disclosed embodiments describe technologies for efficiently coordinating the upgrade of a virtualized network function component (VNFC) running across various virtual machines (VMs), using a service which is configured to perform the upgrade sequence and handle the steps required to perform the upgrade on the VMs and the virtualized infrastructure manager (VIM). Various embodiments disclosed herein describe techniques for implementing a VM upgrade service that is configured to perform the upgrade sequence and handle the steps required for the upgrade on the VMs and the VIM.

The described techniques can allow for a service provider or customer to more efficiently deploy computing resources while maintaining efficient use of computing capacity such as processor cycles, memory, network bandwidth, and power.

This Summary is provided to introduce a selection of concepts in a simplified form that are further described below in the Detailed Description. This Summary is not intended to limit the scope of the claimed subject matter.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example architecture in accordance with the present disclosure;

FIG. 2 is a diagram illustrating an example architecture in accordance with the present disclosure;

FIG. 3 is a diagram illustrating an example architecture in accordance with the present disclosure;

FIG. 4 is a diagram illustrating an example architecture in accordance with the present disclosure;

FIG. 5 is a diagram illustrating an example architecture in accordance with the present disclosure;

FIG. 6A is a flowchart depicting an example procedure for managing computing resources in accordance with the present disclosure;

FIG. 6B is a flowchart depicting an example procedure for managing computing resources in accordance with the present disclosure;

FIG. 7 is an example computing system in accordance with the present disclosure.

### DETAILED DESCRIPTION

The disclosed embodiments describe technologies for efficiently coordinating the upgrade of a virtualized network function component (VNFC) running across various virtual machines (VMs), using a service which is configured to perform the upgrade sequence and handle the steps required to perform the upgrade on the VMs and the virtualized infrastructure manager (VIM).

Many services provided by service providers are implemented in the context of a microservices architecture where software is delivered as smaller, fine-grained, loosely coupled, and independently scalable units that are configured to provide a service. A microservices architecture typically relies on the platform/infrastructure, for example, to coordinate and manage upgrades of software across a large pool of virtual machines/containers providing that service. For containers, many services are built around Kubernetes for providing such processes. However, when the microservices are packaged as VMs that may in turn run on potentially different clouds (e.g., on VMware, vSphere, or OpenStack for example), there is no easy way to efficiently perform the upgrade process. Upgrading a virtualized network function (VNF) may involve upgrading various VNFCs, each of which may comprise a pool of VNFC instances (VNFCIs) or VMs.

One key issue that can prevent efficient automation is that the steps that must be performed when upgrading a specific VM may vary from VM to VM. As an upgrade typically entails a loss of function because the VM is removed and replaced by an updated version, the steps required to do so in a safe manner may differ. For some functions, the VM may require that other nodes that the VM is communicating with are informed that the VM is going down so that the nodes can reroute traffic or reconnect, or otherwise risk an outage. In some cases, the VM may simply need to complete any current processing to avoid losing data, but otherwise does not need to provide notifications. In other situations, it may be preferable for the VM to be restarted as quickly as possible without any further actions.

In addition, performance of upgrades often requires the cloud environment to take actions, as upgrading a VM requires the cloud environment to remove the VM and replace it with a new up-to-date version (rather than the VM itself changing the software). While the cloud environment can remove and create VMs, the specific steps to do so may differ in different cloud environments. Such actions may be performed by a virtualized infrastructure manager (VIM) for the cloud environment. Typically, each cloud environment may have a different VIM.

Thus if there are m different microservices, and n different VM cloud environments, there could potentially be n*m different procedures for performing an upgrade. It would be preferable to provide a mechanism for microservice developers to describe upgrade mechanisms as a configuration and provide tooling that can enact that upgrade on any VIM, without that microservice development team having to understand and account for details of the particular environment (i.e., VIM) for the deployment.

Existing approaches to solving these issues can include:
provide a common function on the VM images: e.g., all VMs would have a single way to define a healthy condition and how to ‘quiesce’, which can include an agent on the VM; however, this means that the upgrade procedure places a restriction on the VM, and thus would not be easy to extend control of the lifecycle of VMs where you do not control the creation of the VM image, such as with a third party VM.
for stateless protocols, a rolling upgrade procedure may include tearing down VMs and recreating them up-level; however, when dealing with stateful protocols, such as SIP message processing, there is a need for a quiesce step before an upgrade, which is typically overlooked when performing orchestration.
orchestrators, such as Cloudify, also have the ability to define hooks into plugins, which can run arbitrary product-specific logic points in a workflow; however such orchestrators are typically not VIM agnostic.

The disclosed embodiments describe technologies for coordinating and managing the upgrade of a VNFC running across various virtual machines (VMs). In an embodiment, a VM upgrade service may be implemented that is configured to perform the upgrade sequence and handle the steps required for the upgrade on the VMs and the VIM. This VM upgrade service may allow service providers and customer users to more efficiently implement upgrades and thus effectively adhere to operational objectives and at the same time improve operating efficiencies.

While the examples herein are described with reference to virtual machines, it should be understood that other embodiments may include other types of virtualized components while implementing the described techniques. Additionally, the disclosed embodiments may be applied to performance of upgrades of clusters across multiple cloud deployments.

In some embodiments, the present disclosure may be implemented in a mobile edge computing (MEC) environment implemented in conjunction with a 4 G, 5G, or other cellular network. MEC is a type of edge computing that uses cellular networks and 5 G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

Referring to the appended drawings, in which like numerals represent like elements throughout the several FIGURES, aspects of various technologies for remote management of computing resources will be described. In the following detailed description, references are made to the accompanying drawings that form a part hereof, and which are shown by way of illustration specific configurations or examples. While many examples are described using servers and disks, it should be understood that other types of compute nodes and storage devices may be used in other embodiments.

In an embodiment, an upgrade of a cluster of virtual machines may be abstracted as the following method of procedure (MOP):

On each VM in the cluster providing the micro-service in turn:

1. A health check action, that checks that the VM is healthy. Performing an upgrade when the VM is in an unhealthy state may have unexpected side-effects. This step may be optional.

2. A microservice specific: “quiesce” or “decommission” action, that interacts with VM to stop the VM from providing services
A reporting mechanism that the “quiesce” or “decommission” action has successfully completed

3. A VIM specific action to delete the VM that is running down-level software:
This may include removal of the server, and may include detaching a persistent disk or NICs attached to the microservice,

4. A VIM specific action to deploy a new VM, with up-level software:
This includes creating the server, and may include re-attaching any persistent disks or NICs attached to the microservice,

5. A microservice specific “health check” action that interacts with the VM and checks that the VM is healthy and is able to provide service.

In an embodiment, a service may be implemented that is configured to perform the upgrade operations described above. The service may be referred to herein as the SIMPL VM. The SIMPL VM may be configured to perform steps 3 and 4 on each VIM in a microservice-agnostic, VIM-specific way.

For each microservice, a release package may be generated that contains the software image to be upgraded to, as well as one or more configuration files that can be read by the SIMPL VM. The SIMPL VM need not have specific knowledge about a particular microservice. Rather, the SIMPL VM needs only to understand the configuration files in the release package which can declare what health checks to perform, what quiesce steps to take (in an embodiment, these may be Ansible scripts), and what persistent volumes this service has. In an embodiment, YAML configuration files may be used. The SIMPL VM can then perform upgrades, by interspersing the microservice-agnostic, VIM-specific steps that it has received, and the microservice-specific, VIM-agnostic steps, as defined in the release package. For simplicity the steps are illustrated in a sequential fashion. However, at least some of the steps may be performed in parallel (e.g., upgrading a n+k cluster, k nodes at a time).

Another problem in a micro-service architecture is the coordination of changes across connected VNFCs (e.g., to upgrade a VNF, all instances of VNFC A must be upgrade to V2 first, before any instance of VNFC B can be upgraded to V2). In an embodiment, a declaration may be provided in a configuration indicating an upgrade ordering (e.g., a set of minimum versions), and a VNFC-specific way to determine the version currently running. Based on the configuration, the upgrade ordering can be managed, thus preventing the VNFC from being upgraded in the wrong order. The SIMPL VM need not determine details of “VNFC A” and “VNFC B” at build time. For example, if the SIMPL VM has the following:
A release package for VNFC A which declares in the configuration (such as an Ansible script) a way to determine all instances of VNFC ′A's version
A release package for VNFC B which declares in the configuration that it cannot be upgraded until all VNFC ′A′ VMs are at version X
An inventory of all the VMs providing VNFC A and VNFC B respectively

then the SIMPL VM may be able to manage the upgrade and enable an effective way to upgrade a VNF by providing a general way to upgrade VNFCs in order, and a generalizable way to upgrade VNFCIs within a VNFC in a rolling fashion.

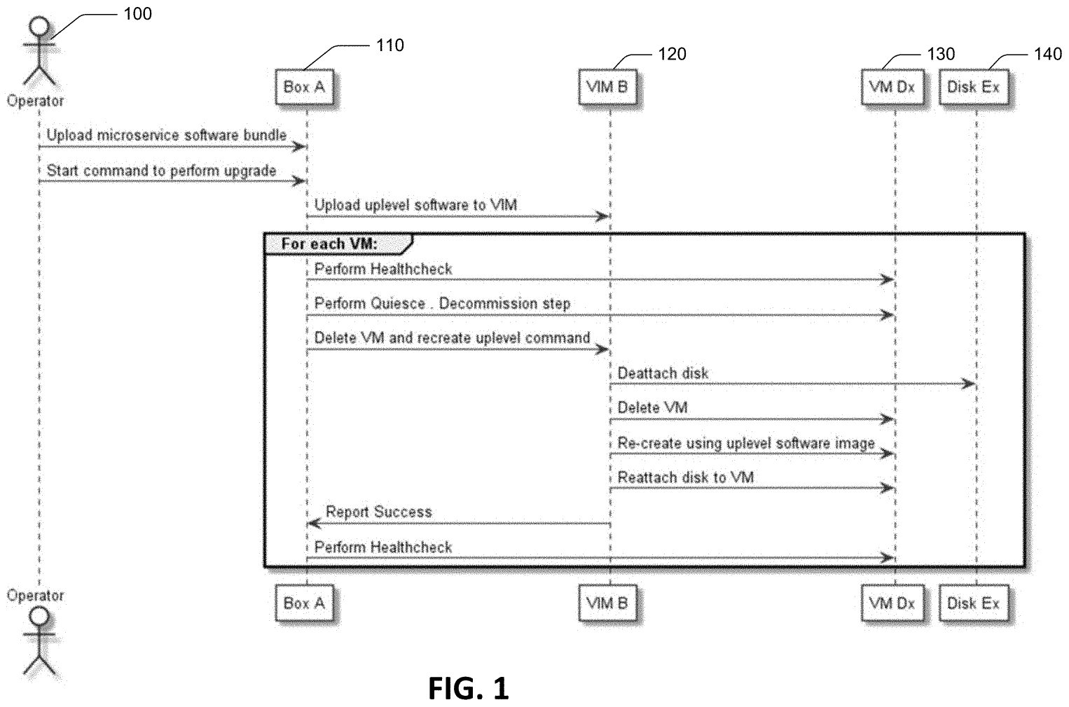

Examples of the steps and components described above are illustrated with reference to FIG. 1. The SIMPL VM component 110, which may be, for example, a virtual machine, may be deployed in a target environment that includes a VIM 120 and one or more VMs 130 that may further be attached to one or more storage devices 140. The SIMPL VM component 110 may receive a microservice software package that may be initiated by an operator 100. In an embodiment, the operator 100 may send a command to perform an upgrade based on the software bundle. The software bundle may include the new version of the software as well as configurations for performing the upgrade as discussed above. The configuration format may be human- and machine-readable format which may be automatically or manually generated based on existing documentation and/or user inputs prior to use of the SIMPL VM component 110.

The SIMPL VM component 110 may be invoked (for example by running a command in a terminal session) and it may read the configuration and receive the uplevel software.

The SIMPL VM component 110 may upload the uplevel software to the VIM 120. For each VM to be upgraded, the SIMPL VM component 110 may perform a health check, and perform a quiesce or decommission step. As appropriate for the target environment, the SIMPL VM component 110 may send an instruction to delete a VM and recreate the uplevel command. The VIM 120 may detach attached disks 140 as appropriate, delete the VM, re-create the VM using the uplevel software image, and reattach the disk 140 to the upleveled VM. The VIM 120 may further report whether the upgrade was successful. The SIMPL VM component 110 may perform a healthcheck on the upleveled VM to confirm that the upleveled VM is operating.

In some embodiments the SIMPL VM component 110 may generate a report containing results of the upgrade operations. The report 140 may be generated in a format (for example, CSV) that may be read directly or imported into downstream reporting or auditing tools.

The disclosed embodiments are advantageous in that no requirements are imposed on what software is on the VMs, and no special upgrade code is needed to effect the upgrade. The disclosed embodiments provide an efficient way to perform upgrades of different environments (e.g., there is no need for an agent on the VM, nor any assumptions about the VM itself), therefore enabling orchestration of VMs from multiple vendors. Additionally, the development team need not write code to effect the upgrade, and only need to prepare the configuration files. When a new VIM is implemented, new interactions with the VIM need only be defined once, and the upgrade procedure can be automatically generated. Finally, upgrades may be performed in a microservice-agnostic way, which may enable coordinating upgrades across connected microservices.

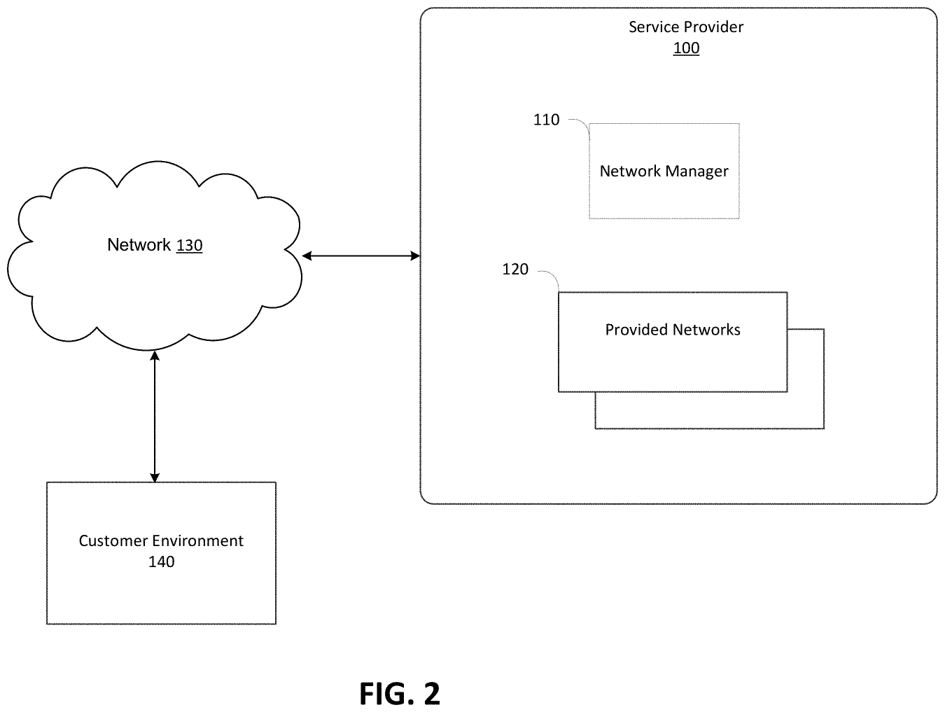

FIG. 2 illustrates an example computing environment in which the embodiments described herein may be implemented. FIG. 2 illustrates a service provider 100 that is configured to provide computing resources to users at customer environment 140. The customer environment 140 may have user computers that may access services provided by service provider 100 via a network 130. The computing resources provided by the service provider 100 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like.

Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor). Networking resources may include virtual networking, software load balancer, and the like. The virtual machines may be configured to execute applications, including Web servers, application servers, media servers, database servers, and the like. Data storage resources may include file storage devices, block storage devices, and the like.

Service provider 100 may have various computing resources including servers, routers, and other devices that may provide remotely accessible computing and network resources using, for example, virtual machines. Other resources that may be provided include data storage resources. Service provider 100 may also execute functions that manage and control allocation of network resources, such as a network manager 110.

Network 130 may, for example, be a publicly accessible network of linked networks and may be operated by various entities, such as the Internet. In other embodiments, network 130 may be a private network, such as a dedicated network that is wholly or partially inaccessible to the public. Network 130 may provide access to computers and other devices at the customer environment 140.

The disclosed embodiments may be implemented in a mobile edge computing (MEC) environment implemented in conjunction with a 4 G, 5G, or other cellular network. The MEC environment may include at least some of the components and functionality described in FIG. 1 above. Additionally, components of a 5G network may include network functions such as a Session Management Function (SMF), Policy Control Function (PCF), and N7 interface. A radio access network (RAN) may comprise 5 G-capable UEs, a base station gNodeB that communicates with an Access and Mobility Management Function (AMF) in a 5G Core (5 GC) network. The 5G network may further comprise a User Plane Function (UPF) and Policy Charging Function (PCF).

It should be appreciated that although the embodiments disclosed above are discussed in the context of virtual machines, other types of implementations can be utilized with the concepts and technologies disclosed herein. It should be also appreciated that the network topology illustrated in FIG. 2 has been greatly simplified and that many more networks and networking devices may be utilized to interconnect the various computing systems disclosed herein. These network topologies and devices should be apparent to those skilled in the art.

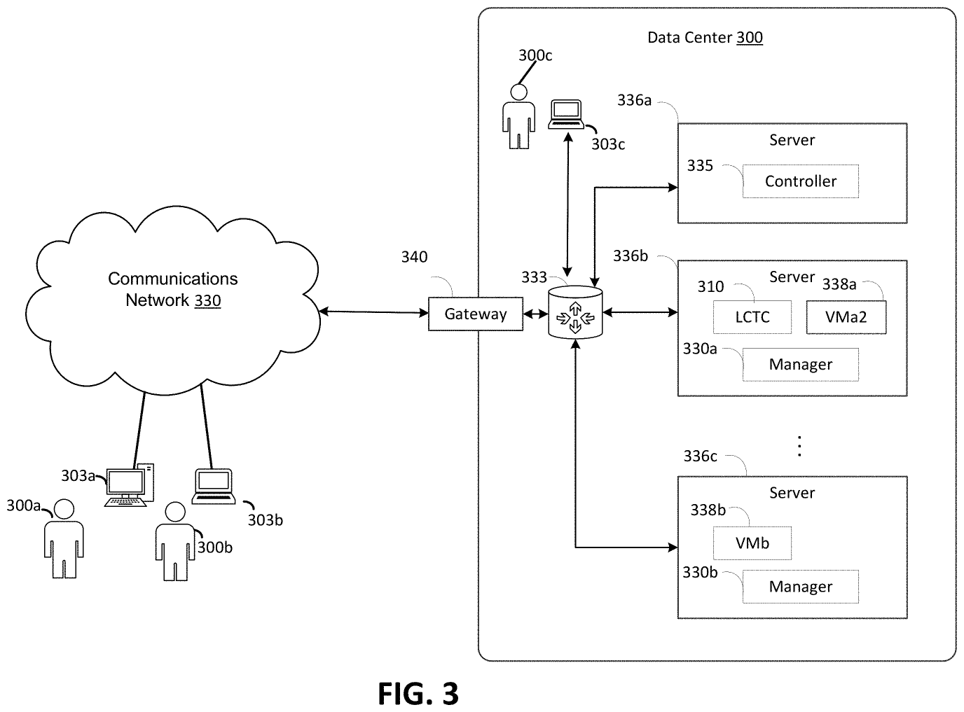

FIG. 3 illustrates an example computing environment in which the embodiments described herein may be implemented. FIG. 3 illustrates a data center 300 that is configured to provide computing resources to users 300a, 300b, or 300c (which may be referred herein singularly as “a user 300” or in the plural as “the users 300”) via user computers 303a,303b, and 303c (which may be referred herein singularly as “a computer 303” or in the plural as “the computers 303”) via a communications network 330. The computing resources provided by the data center 300 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 300 may correspond to data center 100 and 110 of FIG. 2. Data center 300 may include servers 336a, 336b, and 336c (which may be referred to herein singularly as “a server 336” or in the plural as “the servers 336”) that may be standalone or installed in server racks, and provide computing resources available as virtual machines 338a and 338b (which may be referred to herein singularly as “a virtual machine 338” or in the plural as “the virtual machines 338”). The virtual machines 338 may be configured to execute applications such as Web servers, application servers, media servers, database servers, and the like. Other resources that may be provided include data storage resources (not shown on FIG. 3) and may include file storage devices, block storage devices, and the like. Servers 336 may also execute functions that manage and control allocation of resources in the data center, such as a controller 335. Controller 335 may be a fabric controller or another type of program configured to manage the allocation of virtual machines on servers 336.

In an embodiment, a lightweight connectivity test component (LCTC) 310 as described herein may be implemented in server 336b.

Referring to FIG. 3, communications network 330 may, for example, be a publicly accessible network of linked networks and may be operated by various entities, such as the Internet. In other embodiments, communications network 330 may be a private network, such as a corporate network that is wholly or partially inaccessible to the public.

Communications network 330 may provide access to computers 303. Computers 303 may be computers utilized by users 300. Computer 303a, 303b or 303c may be a server, a desktop or laptop personal computer, a tablet computer, a smartphone, a set-top box, or any other computing device capable of accessing data center 300. User computer 303a or 303b may connect directly to the Internet (e.g., via a cable modem). User computer 303c may be internal to the data center 300 and may connect directly to the resources in the data center 300 via internal networks. Although only three user computers 303a,303b, and 303c are depicted, it should be appreciated that there may be multiple user computers.

Computers 303 may also be utilized to configure aspects of the computing resources provided by data center 300. For example, data center 300 may provide a Web interface through which aspects of its operation may be configured through the use of a Web browser application program executing on user computer 303. Alternatively, a stand-alone application program executing on user computer 303 may be used to access an application programming interface (API) exposed by data center 300 for performing the configuration operations.

Servers 336 may be configured to provide the computing resources described above. One or more of the servers 336 may be configured to execute a manager 330a or 330b (which may be referred herein singularly as “a manager 330” or in the plural as “the managers 330”) configured to execute the virtual machines. The managers 330 may be a virtual machine monitor (VMM), fabric controller, or another type of program configured to enable the execution of virtual machines 338 on servers 336, for example.

It should be appreciated that although the embodiments disclosed above are discussed in the context of virtual machines, other types of implementations can be utilized with the concepts and technologies disclosed herein.

In the example data center 300 shown in FIG. 3, a network device 333 may be utilized to interconnect the servers 336a and 336b. Network device 333 may comprise one or more switches, routers, or other network devices. Network device 333 may also be connected to gateway 340, which is connected to communications network 330. Network device 333 may facilitate communications within networks in data center 300, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that data center 300 described in FIG. 3 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

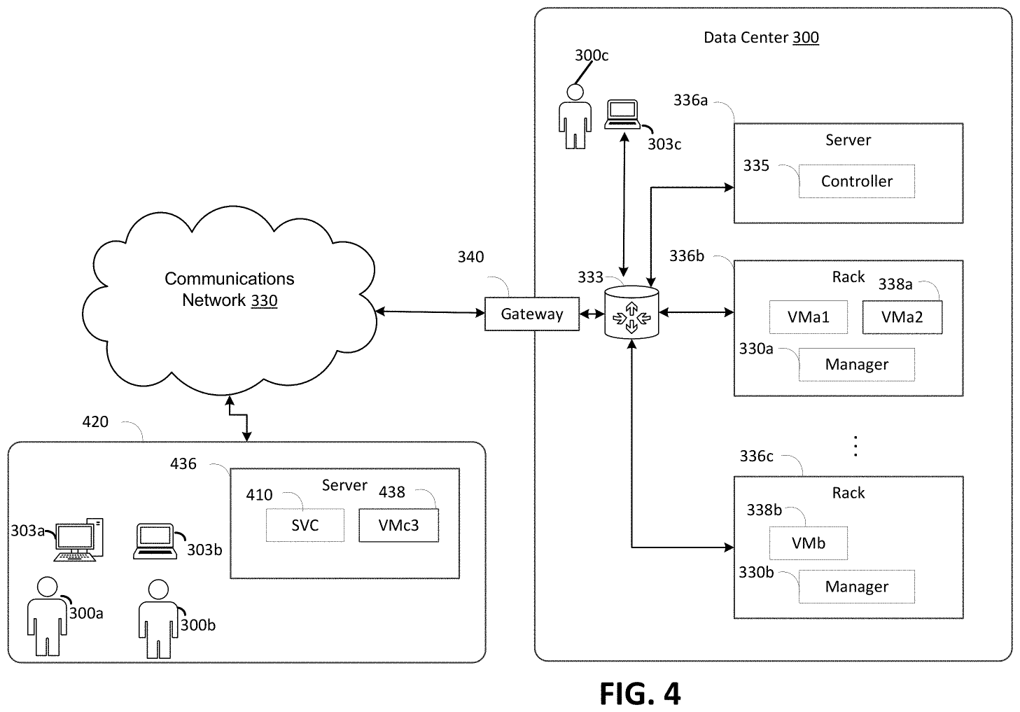

FIG. 4 illustrates an example computing environment illustrating connectivity testing at deployment site 420, in accordance with the present disclosure. In one embodiment, one or more servers 436 may be installed at the edge site 420. In an embodiment, servers 436 instantiate and run virtual machines 438. In an embodiment, a SIMPL VM component (SVC) 410 as described herein may be implemented in server 436.

In some embodiments, users 300 may specify configuration information for a virtual network to be provided for the user, with the configuration information optionally including a variety of types of information such as network addresses to be assigned to computing endpoints of the provided computer network, network topology information for the provided computer network, network access constraints for the provided computer network. The network addresses may include, for example, one or more ranges of network addresses, which may correspond to a subset of virtual or private network addresses used for the user's private computer network. The network topology information may indicate, for example, subsets of the computing endpoints to be grouped together, such as by specifying networking devices to be part of the provided computer network, or by otherwise indicating subnets of the provided computer network or other groupings of the provided computer network. The network access constraint information may indicate, for example, for each of the provided computer network's computing endpoints, which other computing endpoints may intercommunicate with the computing node endpoint, or the types of communications allowed to/from the computing endpoints.

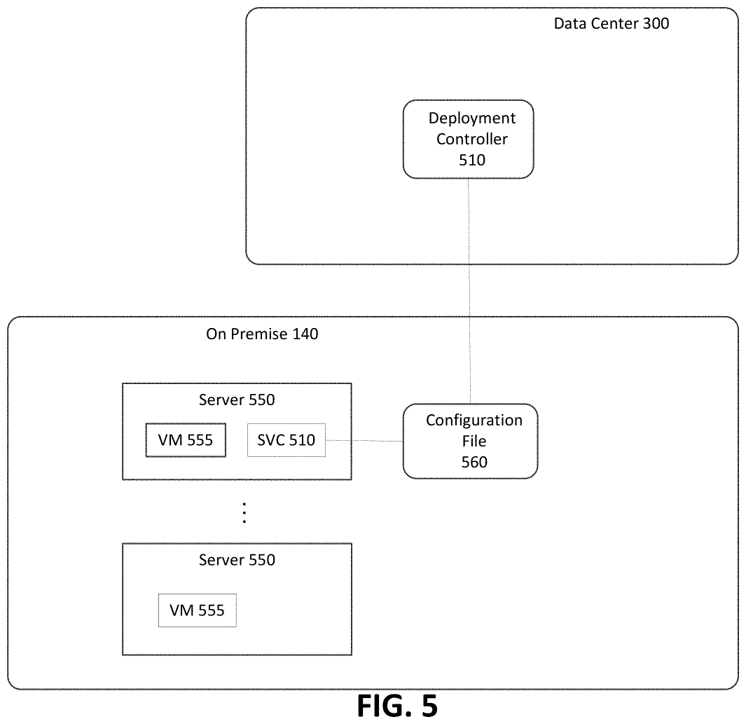

With reference to FIG. 5, illustrated is one example architecture for efficiently coordinating the upgrade of a VNFC running across various VMs. In an embodiment, the architecture may include a deployment controller 510. In some embodiments, the deployment controller 510 may be configured to provide a centralized point of automated control to manage, configure, monitor, and troubleshoot VMs and VNFC at the customer deployment environment 140. The deployment controller 510 may enable automatic configuration of and execution of a SIMPL VM component (SVC) 510.

The architecture may further provide a configuration file 560 as further described herein, which may be configured to identify operations for upgrading VNFCs by SVC 510.

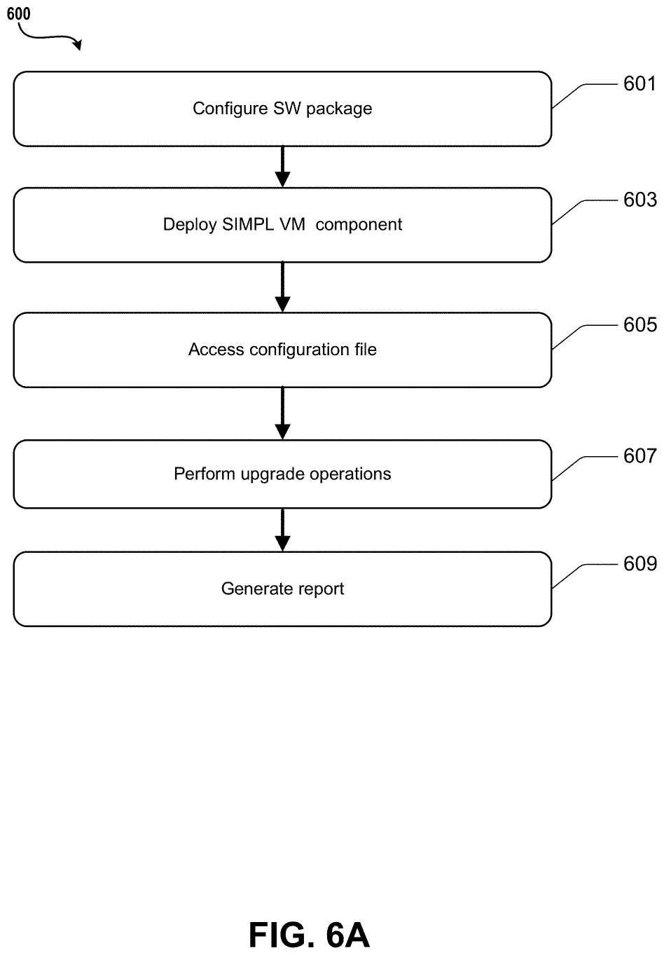

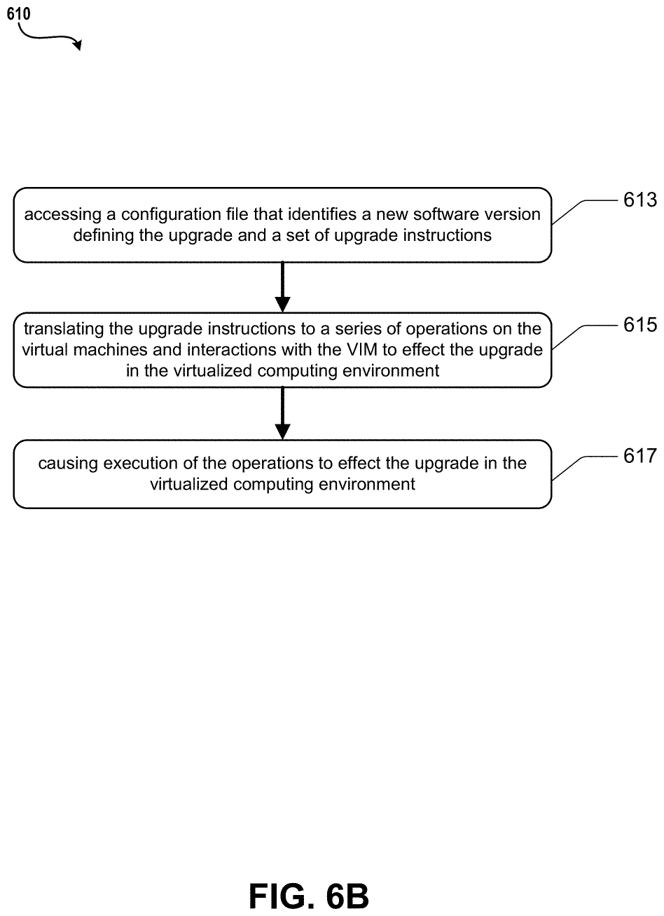

Turning now to FIG. 6A, illustrated is an example operational procedure for efficiently coordinating the upgrade of a VNFC running across various VMs in accordance with the present disclosure. In an embodiment, the computing environment comprises a computing service provider and a remote computing network.

Referring to FIG. 6A, operation 601 illustrates configuring the software package. Operation 601 may be followed by operation 603. Operation 603 illustrates deploying the SIMPL VM component. Operation 603 may be followed by operation 605. Operation 605 illustrates accessing a configuration file. Operation 605 may be followed by operation 607. Operation 607 illustrates performing upgrade operations in accordance with the configuration file. Operation 607 may be followed by operation 609. Operation 609 illustrates generating a report based on the upgrade results.

Turning now to FIG. 6B, illustrated is an example operational procedure for upgrading a virtualized network function (VNF) implemented in a virtualized computing environment configured in a user-specific configuration, the virtualized network function implemented by a plurality of VNF components (VNFCs) executing in a plurality of virtual machines managed by a virtualized infrastructure manager (VIM). In an embodiment, the updating performed by an upgrade component configured to execute as a virtual resource in the virtualized computing environment, execute a series of operations in the virtualized computing environment that coordinate an upgrade of the VNFCs implementing the VNF, and interact with the VIM and the virtual machines to effect the upgrade. Such an operational procedure can be provided by one or more components illustrated in FIGS. 1 through 5. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 300 is described as running on a system, it can be appreciated that the routine 300 and other operations described herein can be executed on an individual computing device or several devices.

Referring to FIG. 6B, operation 613 illustrates accessing a configuration file that identifies a new software version defining the upgrade and a set of upgrade instructions.

Operation 613 may be followed by operation 615. Operation 615 illustrates based on the configuration file, translating the upgrade instructions to a series of operations on the virtual machines and interactions with the VIM to effect the upgrade in the virtualized computing environment.

Operation 615 may be followed by operation 617. Operation 617 illustrates based on the translated upgrade instructions, causing execution of the operations to effect the upgrade in the virtualized computing environment.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like; b) a case in which at least some tasks are implemented in soft (configurable) FPGA logic or the like; c) a case in which at least some tasks run as software on FPGA software processor overlays or the like; d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

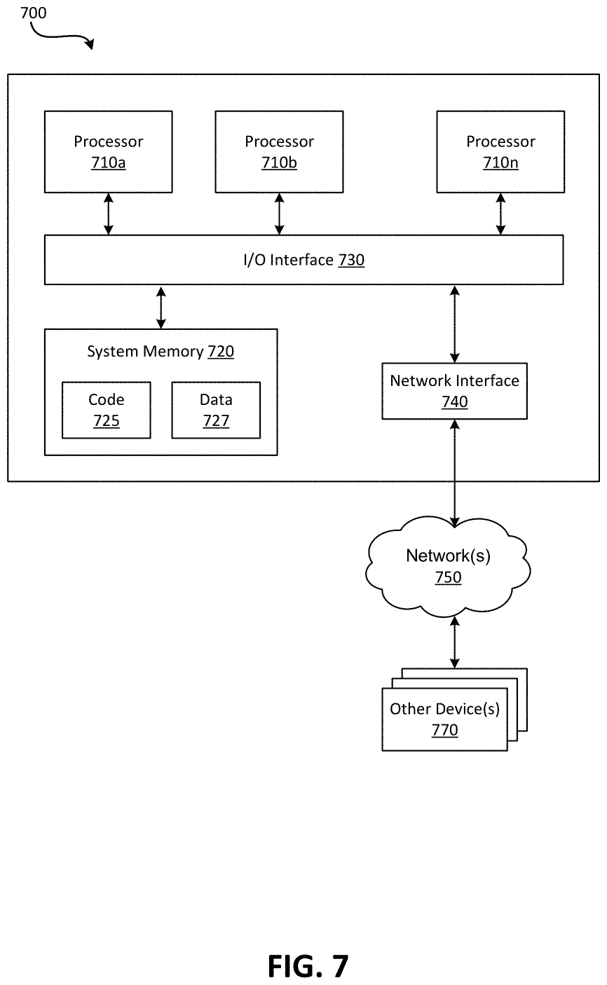

FIG. 7 illustrates a general-purpose computing device 700. In the illustrated embodiment, computing device 700 includes one or more processors 710a, 710b, and/or 710n (which may be referred herein singularly as “a processor 710” or in the plural as “the processors 710”) coupled to a system memory 720 via an input/output (I/O) interface 730. Computing device 700 further includes a network interface 740 coupled to I/O interface 730.

In various embodiments, computing device 700 may be a uniprocessor system including one processor 710 or a multiprocessor system including several processors 710 (e.g., two, four, eight, or another suitable number). Processors 710 may be any suitable processors capable of executing instructions. For example, in various embodiments, processors 710 may be general-purpose or embedded processors implementing any of a variety of instruction set architectures (ISAs), such as the x77, PowerPC, SPARC, or MIPS ISAs, or any other suitable ISA. In multiprocessor systems, each of processors 710 may commonly, but not necessarily, implement the same ISA.

System memory 720 may be configured to store instructions and data accessible by processor(s) 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 720 as code 725 and data 727.

In one embodiment, I/O interface 730 may be configured to coordinate I/O traffic between the processor 710, system memory 720, and any peripheral devices in the device, including network interface 740 or other peripheral interfaces. In some embodiments, I/O interface 730 may perform any necessary protocol, timing, or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components. Also, in some embodiments some or all of the functionality of I/O interface 730, such as an interface to system memory 720, may be incorporated directly into processor 710.

Network interface 740 may be configured to allow data to be exchanged between computing device 700 and other device or devices 770 attached to a network or network(s) 750, such as other computer systems or devices as illustrated in FIGS. 1 through 5, for example. In various embodiments, network interface 740 may support communication via any suitable wired or wireless general data networks, such as types of Ethernet networks, for example. Additionally, network interface 740 may support communication via telecommunications/telephony networks such as analog voice networks or digital fiber communications networks, via storage area networks such as Fibre Channel SANs or via any other suitable type of network and/or protocol.

In some embodiments, system memory 820 may be one embodiment of a computer-accessible medium configured to store program instructions and data as described above for FIGS. 1-8 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 700 via I/O interface 730. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 700 as system memory 720 or another type of memory. Further, a computer-accessible medium may include transmission media or signals such as electrical, electromagnetic or digital signals, conveyed via a communication medium such as a network and/or a wireless link, such as may be implemented via network interface 740. Portions or all of multiple computing devices, such as those illustrated in FIG. 7, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 7, may include other components that are not explicitly shown in FIG. 7, or may utilize an architecture completely different than that shown in FIG. 7.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. The disclosure presented herein also encompasses the subject matter set forth in the following clauses:

Clause 1: A method for upgrading a virtualized network function (VNF) implemented in a virtualized computing environment configured in a user-specific configuration, the virtualized network function implemented by a plurality of VNF components (VNFCs) executing in a plurality of virtual machines managed by a virtualized infrastructure manager (VIM), the updating performed by an upgrade component configured to:
execute as a virtual resource in the virtualized computing environment;
execute a series of operations in the virtualized computing environment that coordinate an upgrade of the VNFCs implementing the VNF; and
interact with the VIM and the virtual machines to effect the upgrade;

the method comprising:

accessing a configuration file that identifies a new software version defining the upgrade and a set of upgrade instructions;

based on the configuration file, translating the upgrade instructions to a series of operations on the virtual machines and interactions with the VIM to effect the upgrade in the virtualized computing environment; and based on the translated upgrade instructions, causing execution of the operations to effect the upgrade in the virtualized computing environment.

Clause 2: The method of clause 1, wherein the upgrade instructions are abstracted from underlying details of the user-specific configuration of the virtualized computing environment.

Clause 3: The method of any of clauses 1-2, wherein the upgrade component is configured with a minimal amount of resources needed to execute in the virtualized computing environment.

Clause 4: The method of any of clauses 1-3, further comprising performing a health check of the virtual machines prior to effecting the upgrade.

Clause 5: The method of any of clauses 1-4, further comprising performing a health check of the virtual machines subsequent to effecting the upgrade.

Clause 6: The method of any of clauses 1-5, wherein the operations include a safe deactivation of the virtual machines.

Clause 7: The method of clauses 1-6, wherein the interactions with the VIM include causing deletion of the virtual machines and deploying new virtual machines running the new software version.

Clause 8: The method of any of clauses 1-7, wherein the interactions with the VIM include causing detachment of persistent disks attached to the virtual machines.

Clause 9: A system comprising:

one or more processors; and

a memory in communication with the one or more processors, the memory having computer-readable instructions stored thereupon that, when executed by the one or more processors, cause the system to perform operations comprising:

generate an upgrade component configured to:
execute as a computing resource in a target computing environment configured in a user-specific configuration, the target computing environment implementing a virtualized network function (VNF) implemented by a plurality of VNF components (VNFCs) executing in a plurality of virtual machines managed by a virtualized infrastructure manager (VIM);
execute a series of operations in the virtualized computing environment that coordinate an upgrade of the VNFCs implementing the VNF; and
interact with the VIM and the virtual machines to effect the upgrade;

generate a configuration file that includes a new software version defining the upgrade and a set of upgrade instructions;

send the upgrade component and configuration file to the target computing environment;

causing execution of the upgrade component in the target computing environment, the upgrade component executed using the configuration file; and

receiving an output from the upgrade component, the output indicative of results of the upgrade in accordance with the configuration file.

Clause 10: The system of clause 9, wherein the target computing environment is a virtualized computing environment and the computing resource is a virtual machine.

Clause 11: The system of any of clauses 9 and 10, wherein the upgrade instructions are abstracted from underlying details of the user-specific configuration of the virtualized computing environment.

Clause 12: The system of any clauses 9-11, wherein the operations include performing a health check of the virtual machines prior to effecting the upgrade.

Clause 13: The system of any clauses 9-12, wherein the operations include performing a health check of the virtual machines subsequent to effecting the upgrade.

Clause 14: The system of any clauses 9-13, wherein the operations include a deactivation of the virtual machines.

Clause 15: The system of any clauses 9-14, wherein the interactions with the VIM include causing deletion of the virtual machines and deploying new virtual machines running the new software version.

Clause 16: The system of any clauses 9-15, wherein the interactions with the VIM include causing detachment of persistent disks or NICs attached to the virtual machines.

Clause 17: A computer-readable storage medium having computer-executable instructions stored thereupon which, when executed by one or more processors of a system, cause the system to:

instantiate an upgrade component configured to:
execute as a virtual resource in a 5G network comprising networked computing devices configured in a user-specific configuration, the 5G network implementing a virtualized network function (VNF) implemented by a plurality of VNF components (VNFCs) executing in a plurality of virtual machines managed by a virtualized infrastructure manager (VIM);
execute a series of operations in the virtualized computing environment that coordinate an upgrade of the VNFCs implementing the VNF; and
interact with the VIM and the virtual machines to effect the upgrade;

access a configuration file that includes a new software version defining the upgrade and a set of upgrade instructions;

based on the configuration file, translating the upgrade instructions to a series of operations on the virtual machines and interactions with the VIM to effect the upgrade in the 5G network; and based on the translated upgrade instructions, causing execution of the upgrade in the 5G network.

Clause 18: The computer-readable storage medium of clause 17, wherein the upgrade instructions are abstracted from underlying details of the user-specific configuration of the 5G network.

Clause 19: The computer-readable storage medium of any of the clauses 17-18, wherein the interactions with the VIM include causing deletion of the virtual machines and deploying new virtual machines running the new software version.

Clause 20: The computer-readable storage medium of any of the clauses 17-19, wherein the operations include a deactivation of the virtual machines.

1. A method for upgrading a virtualized network function (VNF) implemented in a virtualized computing environment configured in a user-specific configuration, the virtualized network function implemented by a plurality of VNF components (VNFCs) executing in a plurality of virtual machines managed by a virtualized infrastructure manager (VIM), the updating performed by an upgrade component configured to:
execute as a virtual resource in the virtualized computing environment;
execute a series of operations in the virtualized computing environment that coordinate an upgrade of the VNFCs implementing the VNF; and
interact with the VIM and the virtual machines to effect the upgrade;
the method comprising:
accessing a configuration file that identifies a new software version defining the upgrade and a set of upgrade instructions;
based on the configuration file, translating the upgrade instructions to a series of operations on the virtual machines and interactions with the VIM to effect the upgrade in the virtualized computing environment; and
based on the translated upgrade instructions, causing execution of the operations to effect the upgrade in the virtualized computing environment.

2. The method of claim 1, wherein the upgrade instructions are abstracted from underlying details of the user-specific configuration of the virtualized computing environment.

3. The method of claim 1, wherein the upgrade component is configured with a minimal amount of resources needed to execute in the virtualized computing environment.

4. The method of claim 1, further comprising performing a health check of the virtual machines prior to effecting the upgrade.

5. The method of claim 1, further comprising performing a health check of the virtual machines subsequent to effecting the upgrade.

6. The method of claim 1, wherein the operations include a safe deactivation of the virtual machines.

7. The method of claim 1, wherein the interactions with the VIM include causing deletion of the virtual machines and deploying new virtual machines running the new software version.

8. The method of claim 7, wherein the interactions with the VIM include causing detachment of persistent disks attached to the virtual machines.

9. A system comprising:
one or more processors; and
a memory in communication with the one or more processors, the memory having computer-readable instructions stored thereupon that, when executed by the one or more processors, cause the system to perform operations comprising:
generate an upgrade component configured to:
execute as a computing resource in a target computing environment configured in a user-specific configuration, the target computing environment implementing a virtualized network function (VNF) implemented by a plurality of VNF components (VNFCs) executing in a plurality of virtual machines managed by a virtualized infrastructure manager (VIM);
execute a series of operations in the virtualized computing environment that coordinate an upgrade of the VNFCs implementing the VNF; and
interact with the VIM and the virtual machines to effect the upgrade;
generate a configuration file that includes a new software version defining the upgrade and a set of upgrade instructions;
send the upgrade component and configuration file to the target computing environment;
causing execution of the upgrade component in the target computing environment, the upgrade component executed using the configuration file; and
receiving an output from the upgrade component, the output indicative of results of the upgrade in accordance with the configuration file.

10. The system of claim 9, wherein the target computing environment is a virtualized computing environment and the computing resource is a virtual machine.

11. The system of claim 9, wherein the upgrade instructions are abstracted from underlying details of the user-specific configuration of the virtualized computing environment.

12. The system of claim 9, wherein the operations include performing a health check of the virtual machines prior to effecting the upgrade.

13. The system of claim 9, wherein the operations include performing a health check of the virtual machines subsequent to effecting the upgrade.

14. The system of claim 9, wherein the operations include a deactivation of the virtual machines.

15. The system of claim 9, wherein the interactions with the VIM include causing deletion of the virtual machines and deploying new virtual machines running the new software version.

16. The system of claim 15, wherein the interactions with the VIM include causing detachment of persistent disks or NICs attached to the virtual machines.

17. A computer-readable storage medium having computer-executable instructions stored thereupon which, when executed by one or more processors of a system, cause the system to:
instantiate an upgrade component configured to:
execute as a virtual resource in a 5G network comprising networked computing devices configured in a user-specific configuration, the 5G network implementing a virtualized network function (VNF) implemented by a plurality of VNF components (VNFCs) executing in a plurality of virtual machines managed by a virtualized infrastructure manager (VIM);
execute a series of operations in the virtualized computing environment that coordinate an upgrade of the VNFCs implementing the VNF; and
interact with the VIM and the virtual machines to effect the upgrade;
access a configuration file that includes a new software version defining the upgrade and a set of upgrade instructions;
based on the configuration file, translating the upgrade instructions to a series of operations on the virtual machines and interactions with the VIM to effect the upgrade in the 5G network; and
based on the translated upgrade instructions, causing execution of the upgrade in the 5G network.

18. The computer-readable storage medium of claim 17, wherein the upgrade instructions are abstracted from underlying details of the user-specific configuration of the 5G network.

19. The computer-readable storage medium of claim 17, wherein the interactions with the VIM include causing deletion of the virtual machines and deploying new virtual machines running the new software version.

20. The computer-readable storage medium of claim 17, wherein the operations include a deactivation of the virtual machines.
